(19) United States
(12) Patent Application Publication
(10) Pub. No.: US 2002/0116645 A1
(43) Pub. Date: Aug. 22, 2002

(54) System, method, and computer program product for an irrevocable right to use (IRU) modem registration process

(75) Inventors: Leo C. Cloutier, Falls Church, VA (US); Ronald K. Dobes, Potomac Falls, VA (US)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: GEMINI NETWORKS, INC., FALLS CHURCH, VA

(21) Appl. No.: 10/075,195

(22) Filed: Feb. 15, 2002

Related U.S. Application Data
(60) Provisional application No. 60/268,865, filed on Feb. 16, 2001.

(51) Int. Cl. G06F 11/30

(52) U.S. Cl. 713/201; 709/223

(57) ABSTRACT

A computer-implemented method, system and computer program product for an irrevocable right to use (IRU) registration process in a network supporting one or more IRU service providers connected to the network, including performing one of the following sets of steps: (a) performing an end-user login process for a modem communicating on an upstream frequency corresponding to the network, storing an address of the modem and reporting the modem address to an IRU service provider which is to provide IRU service to the modem; and (b) redirecting a modem, communicating on an upstream frequency corresponding to an IRU service provider which is to provide IRU service to the modem, to an end-user login process for the network, storing an address of the modem and reporting the modem address to the IRU service provider.

### CROSS REFERENCE TO RELATED PATENT DOCUMENTS

The present document claims the benefit of the earlier filing date of commonly owned, co-pending U.S. provisional patent application serial No. 60/268,865, entitled “SYSTEM, METHOD, AND COMPUTER PROGRAM PRODUCT FOR AN IRREVOCABLE RIGHT TO USE (IRU) MODEM REGISTRATION PROCESS,” filed in the United States Patent and Trademark Office on Feb. 16, 2001, the entire contents of which is incorporated herein by reference.

The present document contains subject matter related to that disclosed in commonly owned, co-pending: (1) Application Ser. No. 09/784,074 filed Feb. 16, 2001, entitled “SYSTEM, METHOD, AND COMPUTER PROGRAM PRODUCT FOR SUPPORTING MULTIPLE SERVICE PROVIDERS WITH AN INTEGRATED OPERATIONS SUPPORT SYSTEM” (Attorney Docket No. 200876US-8); (2) Application Ser. No. 09/784,068 filed Feb. 16,2001, entitled “METHOD AND SYSTEM OF EXPANDING A CUSTOMER BASE OF A DATA SERVICES PROVIDER” (Attorney Docket No. 202385US-8); (3) Application Ser. No. 09/784,075 filed Feb. 16, 2001, entitled “SYSTEM, METHOD, AND COMPUTER PROGRAM PRODUCT FOR END-USER SELF-AUTHENTICATION” (Attorney Docket No. 202585US-8); (4) Application Ser. No. 09/784,069 filed Feb. 16, 2001, entitled “SYSTEM, METHOD, AND COMPUTER PROGRAM PRODUCT FOR SUPPORTING MULTIPLE SERVICE PROVIDERS WITH A TROUBLE TICKET CAPABILITY” (Attorney Docket No. 202586US-8); (5) Provisional Application Serial No. 60/268,871 filed Feb. 16, 2001, entitled “SYSTEM, METHOD, AND COMPUTER PROGRAM PRODUCT FOR DYNAMIC BANDWIDTH QUALITY OF SERVICE (QOS) PROVISIONING” (Attorney Docket No. 202661US-8 PROV); (6) Provisional Application Serial No. 60/268,870 filed Feb. 16, 2001, entitled “SYSTEM, METHOD, AND COMPUTER PROGRAM PRODUCT FOR DYNAMIC BANDWIDTH PROVISIONING” (Attorney Docket No. 202663US-8 PROV); (7) Provisional Application Serial No. 60/268,896 filed Feb. 16, 2001, entitled “SYSTEM, METHOD, AND COMPUTER PROGRAM PRODUCT FOR END-USER SERVICE PROVIDER SELECTION” (Attorney Docket No. 202664US-8 PROV); (8) Application Ser. No. XX/XXX,XXX, filed XXXXXX, entitled “SYSTEM, METHOD, AND COMPUTER PROGRAM PRODUCT FOR DYNAMIC BANDWIDTH QUALITY OF SERVICE (QOS) PROVISIONING” (Attorney Docket No. 214232US-8); (9) Application Ser. No. XX/XXX,XXX, filed XXXXXXX entitled “SYSTEM, METHOD, AND COMPUTER PROGRAM PRODUCT FOR END-USER SERVICE PROVIDER SELECTION” (Attorney Docket No. 214237US-8); and (10) Application Ser. No. XX/XXX,XXX, filed XXXXX, entitled “SYSTEM, METHOD, AND COMPUTER PROGRAM PRODUCT FOR DYNAMIC BANDWIDTH PROVISIONING” (Attorney Docket No. 214442US-8) the entire contents of each of which being incorporated herein by reference.

### BACKGROUND OF THE INVENTION

1. Field of the Invention

The present invention relates to method, system and computer program product for supporting an Irrevocable Right to Use (IRU) registration process.

2. Discussion of the Background

FIG. 1 is a block diagram of a conventional hybrid fiber optic/coaxial (HFC) network for providing cable television service and access to the Internet over the same cable television provider network. As shown in FIG. 1, the fiber optic network, including both video content and data, is tapped via a tap 102 of a coaxial cable run from a fiber node 101. From the tap 102, a coaxial cable (i.e., a drop) is run to a splitter 103 where the signal is split into its data and cable television content components. The cable television content is run via a coaxial cable to a television set 104. The data portion of the signal is sent via a coaxial cable to a cable modem 105 connected to, for example, a personal computer 106.

In order to ensure interoperability and availability of parts, the devices used in this system comply with industry standards such as the Data Over Cable Service Interface Specification (DOCSIS). In a typical DOCSIS-compliant system, a network having 860 MHz of bandwidth will allocate the band of 5-42 MHz for upstream communications, and the band of 88-860 MHz for downstream communications.

The cable modem termination system (CMTS) 107 provides an interface between the cable network and the Internet. The CMTS 107 provides the data signal to the cable headend 108 which in turn provides connectivity to a backbone 109 provider. The backbone 109 provides the connectivity to the communications network 100, for example, the Internet. The backbone 109 is a network configured to provide access to the Internet. Access to the backbone 109 is provided by, for example, organizations such as UUNET.

The DOCSIS standard applies to all equipment between the cable modem 105 and the CMTS 107. Accordingly, DOCSIS defines a protocol through which existing cable networks may also be used to provide high-speed bidirectional Internet access.

FIG. 2 is a block diagram showing a conventional dial-up network configuration for providing access to the Internet via an existing telephone network. As shown in FIG. 2, an end-user may connect to the network via a personal computer 201 having, for example, a digital subscriber line (DSL) modem 200. The DSL modem 200 interfaces with the telephone network through a digital subscriber line access multiplexer (DSLAM) 202. Similar to the CMTS 107 shown in FIG. 1, the DSLAM 202 is connected to a backbone 109 through a headend 203. The backbone 109, which may be the same backbone 109 shown in FIG. 1, provides connectivity to the Internet 100.

DSL technology allows digital data to coexist with analog voice data over plain old telephone service (POTS) copper wire networks. As DOCSIS enables the use of existing cable networks for Internet access, technologies such as DSL enable the use of existing telephone networks for Internet access.

As the Internet has become a ubiquitous facet of our society, it is understandable that technologies such as DSL and DOCSIS have well-positioned the telephone companies and the cable television (CATV) companies to benefit. The phone companies and the CATV companies had preexisting networks in place providing connectivity to a large percentage of commercial facilities and residences which desire Internet access. As the technologies evolved permitting multiple uses for the preexisting networks, the telephone companies and cable television providers were able to provide additional services to their existing customer base.

New businesses have also developed in response to the demand for Internet access. For example, Roadrunner's business model is to provide high-speed broadband Internet access services to end-users. They do this by entering into agreements with existing CATV companies so as to gain access to the preexisting CATV HFC network. By owning their own headend, they can provide Internet access to end-users by providing connectivity, through their headend, from the CMTS 107 to the backbone 109.

Other Internet service providers (ISPs) make use of the preexisting telephone system network to gain access to end-users. Similar to the Roadrunner model, these ISPs own their own headend, and provide Internet access to end-users by providing connectivity, through their headend, from the DSLAM 202 to the backbone 109. The existing network owners (i.e., the CATV companies and the telephone companies) have developed systems for provisioning new customers, monitoring network status, and for generating billing for network usage. However, these systems have been evolutionary and have not been developed as a single system, but rather, a collection of separate systems, each having their own interfaces and databases. This has led to significant challenges in maintaining data integrity across the systems, and has also impacted user productivity. Not only do the network owners have to deal with these complexities and inefficiencies, but also, the ISPs connecting to these networks must develop interfaces, oftentimes manual interfaces, between the ISP's internal systems and the network owner's systems. This problem is even worse for an ISP such as Roadrunner which has agreements with many CATV companies, each of which has its own heterogeneous system. It becomes increasingly difficult for an ISP to manage its own systems each time an agreement with a new CATV company or a new telephone company having different systems is reached.

As a general statement, ISPs provide the service of connecting end-users to the Internet by entering into agreements with the owners of the existing networks (i.e., the telephone network and CATV networks), and with the providers of the backbone 109 networks (e.g., UUNET). ISPs typically provide a number of services for their customers, for example, e-mail, news, software downloads, etc. Moreover, ISPs provide a single point of contact for an end-user, alleviating the need for each end-user to interact with the network owner and/or the backbone 109 provider regarding their Internet connectivity.

### SUMMARY OF THE INVENTION

The inventors of the present invention have recognized that currently no methods, systems, or computer program products are available to allow an Irrevocable Right to Use (IRU) registration process in an open access network for providing broadband data transport services. The broadband data transport services provided in the context of the present invention may include, but are not limited to any combination of analog video, digital video, data services, Internet access, packetized voice, voice-over-Internet Protocol, interactive video, interactive television, near video-on-demand, video-on-demand, data services, and telephony services. Accordingly, one object of the present invention is to provide a solution to this problem, as well as other problems and deficiencies associated with an Irrevocable Right to Use (IRU) registration process in an open access network for providing broadband data transport services.

The above described and other objects are addressed by the present invention which provides a novel computer-implemented method, system and computer program product for an irrevocable right to use (IRU) registration process in a network supporting one or more IRU service providers connected to the network, including performing one of the following sets of steps: (a) performing an end-user login process for a modem communicating on an upstream frequency corresponding to the network, storing an address of the modem and reporting the modem address to an IRU service provider which is to provide IRU service to the modem; and (b) redirecting a modem, communicating on an upstream frequency corresponding to an IRU service provider which is to provide IRU service to the modem, to an end-user login process for the network, storing an address of the modem and reporting the modem address to the IRU service provider.

Consistent with the title of this section, the above summary is not intended to be an exhaustive discussion of all the features or embodiments of the present invention. A more complete, although not necessarily exhaustive, description of the features and embodiments of the invention is found in the section entitled “DETAILED DESCRIPTION OF THE PREFERRED EMBODIMENTS.”

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a block diagram of a typical system configuration of a hybrid fiber optic/coaxial (HFC) network for providing cable television service and access to the Internet through the cable television provider network;

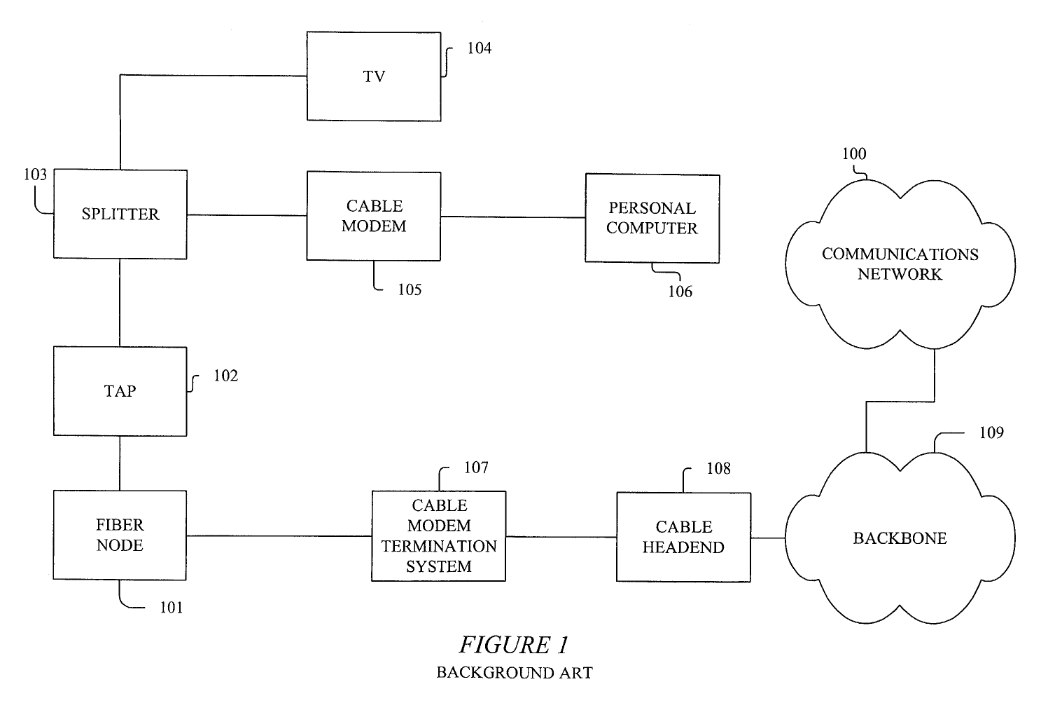

FIG. 2 is a block diagram of a typical dial-up network providing access to the Internet over phone lines;

FIG. 3 is a block diagram of a high-speed network system for providing broadband transport data services (e.g., connecting to an ISP headend to gain access to the Internet) connected to a conventional HFC network providing both cable television and access to a communications network according to one embodiment of the present invention;

FIG. 4 is a block diagram showing the connectivity of multiple hybrid fiber optic/coaxial networks through a single data center of a high-speed network according to one embodiment of the present invention;

FIG. 5 is a block diagram showing the connectivity of remote end-users to geographically based service providers (e.g., an Internet service provider (ISP)) through a high-speed network in one embodiment of the present invention;

FIG. 6 is block diagram showing the connectivity between a common data center of a high-speed network as shown in FIG. 4 and a service provider's (e.g., an ISP) system according to one embodiment of the present invention;

FIG. 7 is a block diagram of a system configuration of an operations support system of a high-speed network to support multiple service providers according to one embodiment of the present invention;

FIG. 8 is a block diagram showing the software architecture of a system for an integrated operations support system of a high-speed network to support multiple service providers according to one embodiment of the present invention;

FIG. 9 shows an exemplary database structure for a database of an operations support system of a high-speed network supporting multiple service providers (e.g., ISPs) according to one embodiment of the present invention;

FIG. 10 is a flow diagram showing an exemplary process for Irrevocable Right to Use (IRU) registration according to one embodiment of the present invention; and

FIG. 11 is an exemplary computer system programmed to perform one or more of the special purpose functions of the present invention.

### DETAILED DESCRIPTION OF THE PREFERRED EMBODIMENTS

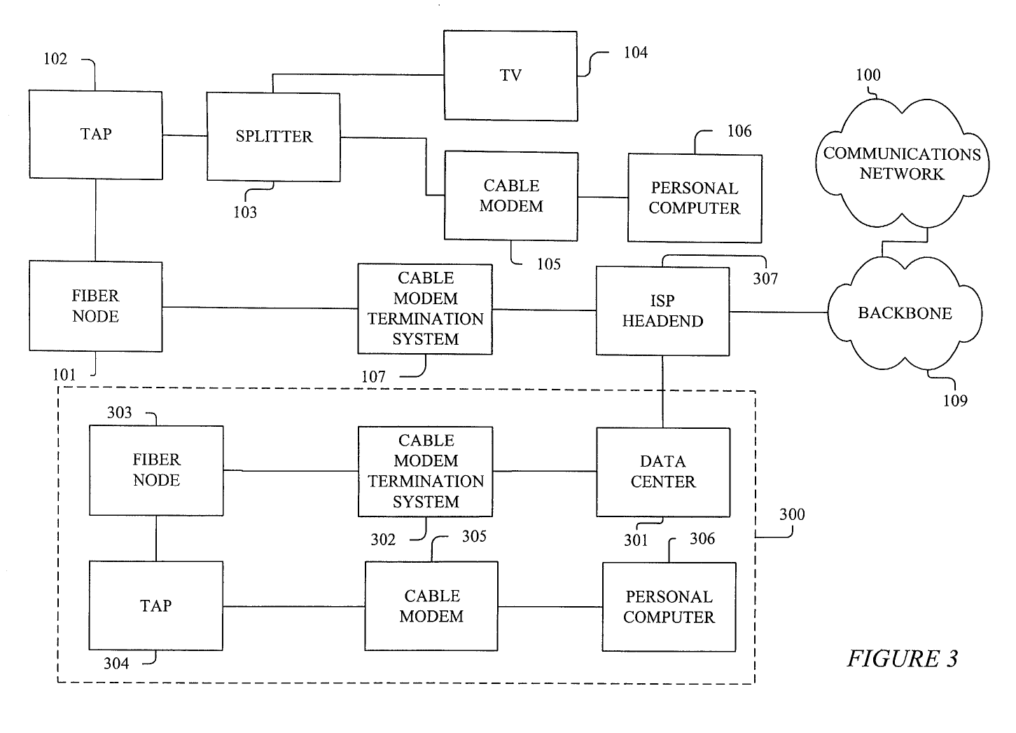

Referring now to the drawings, wherein like reference numerals designate identical or corresponding parts throughout the several views, and more particularly to FIG. 3 thereof, which is a block diagram of a system for providingbroadband data services, including access to a communications network (e.g., the Internet) according to one embodiment of the present invention. The system includes a high-speed network 300 for providingbroadband data transport services. In one embodiment of the present invention, the high-speed network 300 provides end-users with connectivity to an Internet service provider (ISP) headend 307 to gain access to a communications network 100, for example, the Internet. This connectivity may be provided by using the Data Over Cable Service Interface Specification (DOCSIS) protocol for communications between the end-user cable modem 305 and the cable modem termination system (CMTS) 302 of the high-speed network 300. In further embodiments, protocols other than DOCSIS may be used (e.g., Euro-DOCSIS, fast Ethernet, gigabit Ethernet or other proprietary protocols). In another embodiment, the high-speed network 300 provides end-users with connectivity to an Internet backbone network directly (i.e., via the data center 301) on behalf of the ISP. In further embodiments, the broadband data transport services provided in the context of the present invention may include, but are not limited to any combination of analog video, digital video, data services, Internet access, packetized voice, voice-over-Internet Protocol, interactive video, interactive television, near video-on-demand, video-on-demand, data services, and telephony services. The embodiments described herein will be in the context of providing high-speed access to the Internet by providing end-users with connectivity to ISP headends 307. However, as discussed above, the invention is not limited to this particular embodiment nor is it limited to providing access to any particular network.

The high-speed network 300 is a hybrid fiber optic/coaxial (HFC) network similar to existing cable television (CATV) plants. The high-speed network 300 provides connectivity from end-users, for example, through a personal computer 306 having a cable modem 305, through a coaxial cable to a tap 304 of the fiber optic network. The tap 304 connects the end-user to the coaxial cable portion of the HFC network that connects to the fiber optic network at a node 303. The cable modem 305 communicates with the cable modem termination system (CMTS) 302, which in turn provides connectivity for all end-users of the high-speed network 300 to a common data center 301.

The data center 301 provides connectivity from the high-speed network to an Internet service provider's (ISP) headend 307. The ISP headend 307 is the same headend as described in the BACKGROUND OF THE INVENTION section. For example, the ISP headend 307 may be a cable headend 108 of an ISP providing Internet access over an existing cable network, or it may be a headend 203 of an ISP providing Internet access through dialup connections. In one embodiment of the present invention, the high-speed network 300 provides connectivity to a plurality of ISP headends 307. For example, the end-users from CATV operator ISPs and dial-up ISPs coexist on the same high-speed network 300. The data center 301 is responsible for managing the connectivity between the various ISPs and their particular end-user customers. The ISP headend 307 provides the connectivity to the backbone 109, as described above, which in turn provides the connectivity to the communications network 100, for example, the Internet. Various approaches for connecting to the Internet, including DSL and cable modem connections, are described in White, R., “How Computers Work,” Que, September 1999, and Gralla, P. “How the Internet Works,” Que, August 1999, the entire contents of both of which are incorporated herein by reference.

FIG. 3 illustrates two different networks for gaining access to the Internet 100 through a common ISP headend 307. As discussed above, one path is through the high-speed network 300 for providing broadband data transport services. The other is a preexisting CATV network that provides both cable television content and Internet access. The cable television signal is separated from the data signal at the splitter 103, the cable television signal is provided to a television 104, while the data signal is provided to a cable modem 105 connected to a personal computer 106. The splitter 103 is connected via a coaxial cable to the tap 102. The tap 102 connects the end-user to the coaxial cable portion of the HFC network that in turn connects to the to the fiber optic network at the fiber node 101. The cable modem termination system (CMTS) 107 communicates with the cable modem 105 and provides connectivity to the common ISP headend 307.

The inventors of the present invention have recognized that by providing a high-speed network 300 that is dedicated to particular broadband data transport services, as compared to sharing a preexisting network built for cable television or telephone use, significant improvements in performance may be achieved. For example, some embodiments of the present invention are directed to a high-speed network 300 that is dedicated to providing data services only, for example, Internet access. In these embodiments, the bandwidth of the network can be fully dedicated to that service thereby improving the performance. Other embodiments of the present invention, as described above, are directed to a high-speed network 300 that has not been dedicated to providing a particular service, but rather, provides multiple services. A significant portion of the bandwidth of preexisting CATV networks is dedicated to the downstream transmission of the cable television video. For example, a seventy-channel analog video system requires 420 MHz of bandwidth (6 MHz per channel). Accordingly, standards have been developed to work around that limitation. For example, the Data Over Cable Service Interface Specification (DOCSIS) standard provides that, for an 860 MHz bandwidth channel, the band from 88 MHz to 860 MHz would be reserved for downstream communications. Consequently, devices built for use in a data over cable system must limit their upstream bandwidth to the first 42 MHz. Such allocation limitations do not exist where the a high-speed network 300 is dedicated to providing a particular service.

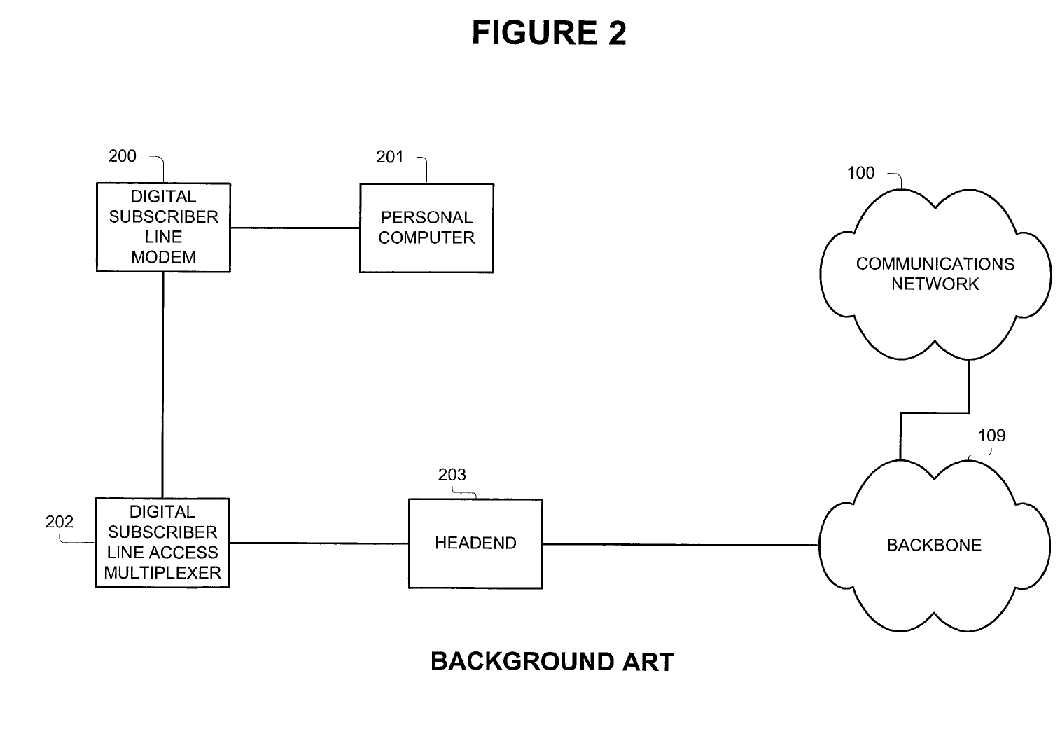

FIG. 3 provides an example showing an ISP headend 307 for a cable provider that also provides Internet access over their cable network. However, this is an exemplary illustration only. The ISP headend 307 could also be a headend 203 for an ISP providing Internet access over telephone lines, as shown in FIG. 2. Alternatively, the ISP headend 307 could be a headend for an Internet service provider such as Roadrunner that provides Internet access through affiliations with various owners of preexisting networks. Moreover, multiple ISP headends 307, of varying types, may be connected to the high-speed network 300 for providing broadband data services.

FIG. 3 illustrates that, in one embodiment of the present invention, an ISP may have connectivity to some customers (i.e., end-users) connected to the ISP headend 307 through its own network, for example, the personal computer 106 connected to the ISP headend 307 through the CMTS 107. In addition, that same ISP may have customers connected to a different, high-speed network 300 for providing broadband data transport services, for example, the personal computer 306 connected to the data center 301 through the CMTS 302. Accordingly, FIG. 3 illustrates that, in one embodiment of the present invention, an ISP may provide services to end-users connected to different networks. In this embodiment, the ISP maintains the relationship with the end-users. If the ISP owns their own network (e.g., a cable television operator) they are responsible for that physical plant as well. If, on the other hand, the ISP does not operate a network (e.g., the Roadrunner example discussed above, where the ISP enters into agreements with the network operators), the ISP must coordinate with the operators of the networks concerning network status, outages, etc. The operator of the high-speed network 300 is responsible for the operation of that plant, and network status information is made available to those ISPs having customers connected to the high-speed network 300.

As discussed above, the present inventors have recognized that Internet connectivity through a high-speed network 300 dedicated to broadband data transport services provides superior performance over conventional approaches. Accordingly, using the system configuration shown in FIG. 3, an ISP could offer enhanced performance to its customers through providing Internet connectivity via the high-speed network 300 dedicated to providing Internet access, rather than via the preexisting cable television network. Moreover, the present inventors have recognized that by providing a high-speed network 300 based on an open access model, many ISPs can expand their customer base by being able to offer their services in geographic regions not currently served, and moreover, ISPs may offer upgraded performance to new and existing customers by connecting those customers to the high-speed network 300 dedicated to that particular broadband data transport service. In those embodiments where the high-speed network 300 is dedicated to, for example, Internet access, the high-speed network 300 will be able to support new network technologies that may either coexist with or replace standards that have been developed to accommodate certain limitations (e.g., the DOCSIS standard assumes the presence of analog cable television on the network).

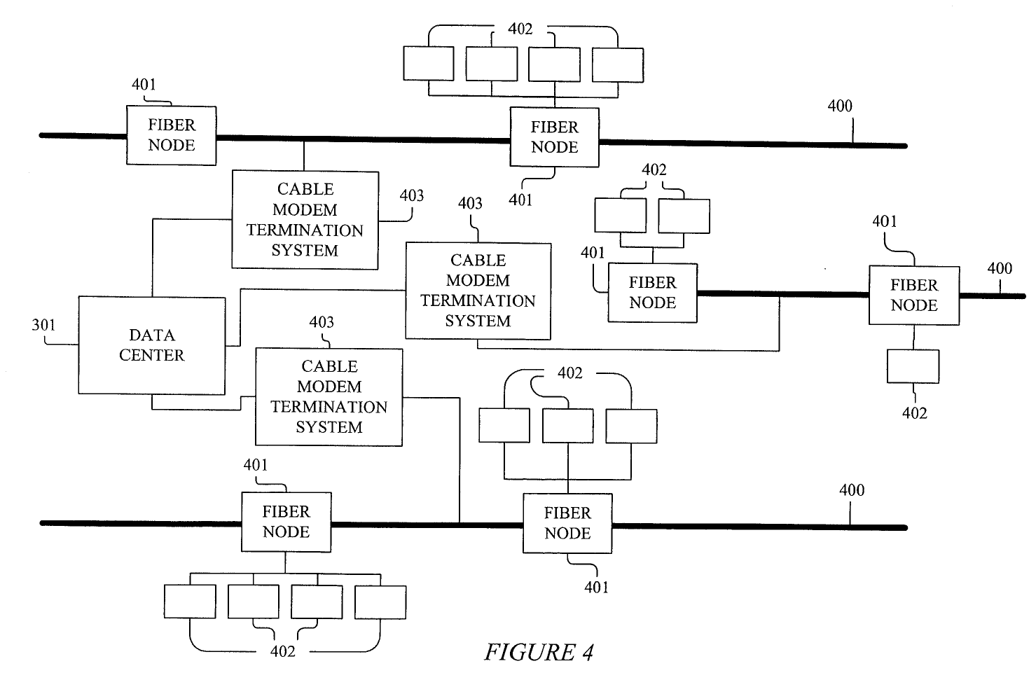

FIG. 4 is a block diagram showing the connectivity of multiple HFC networks through a single data center 301 highlighting another aspect of the present invention. As shown in FIG. 4, the high-speed network simplified as box 300 in FIG. 3 may include several HFC networks 400 that may be geographically dispersed. Each of the HFC networks includes one or more fiber optic nodes 401 that provide connectivity between the fiber optic portion of the network and the coaxial cable portion of the network. For example, each fiber optic node 401 may have connected thereto several end-users 402 via a coaxial cable network. Each end-user 402 is connected to the network, for example, through a cable modem 305. Each of the fiber optic networks 400 is connected to the common data center 301 via a CMTS 403. The common data center 301 provides the connectivity between the geographically dispersed end-users 402 and the various ISP headends 307 having customers on the high-speed network 300.

It was the present inventors who recognized that a limitation faced by cable television providers also providing Internet access was that the CATV network was necessarily limited by the geographic restrictions of the franchise agreements awarded to the cable companies. Accordingly, the reach of a cable company extended only to those end-users within the geographic boundaries of the cable company franchise award. The present inventors recognized that by not tying broadband Internet access services to an HFC system primarily dedicated to carrying analog video signals required by a CATV franchise award, the high-speed network 300 would not be subject to franchise-based geographic restrictions. Accordingly, in those situations, not only will the high-speed network 300 provide superior performance, but also, it may be built-out based on demand, and not subject to regulatory restrictions faced by cable television providers.

The availability of a high-speed network 300 that is not geographically restricted, provides an opportunity for existing ISPs (whether or not they operate their own network) to offer their services beyond the geographic limits of their franchise award or agreements with existing network owners. Connectivity between the ISP headend 307 and the common data center 301 provides connectivity between the ISP and the end-users connected to the high-speed network 300 dedicated to broadband data transport services, regardless of the geographic location of those end-users.

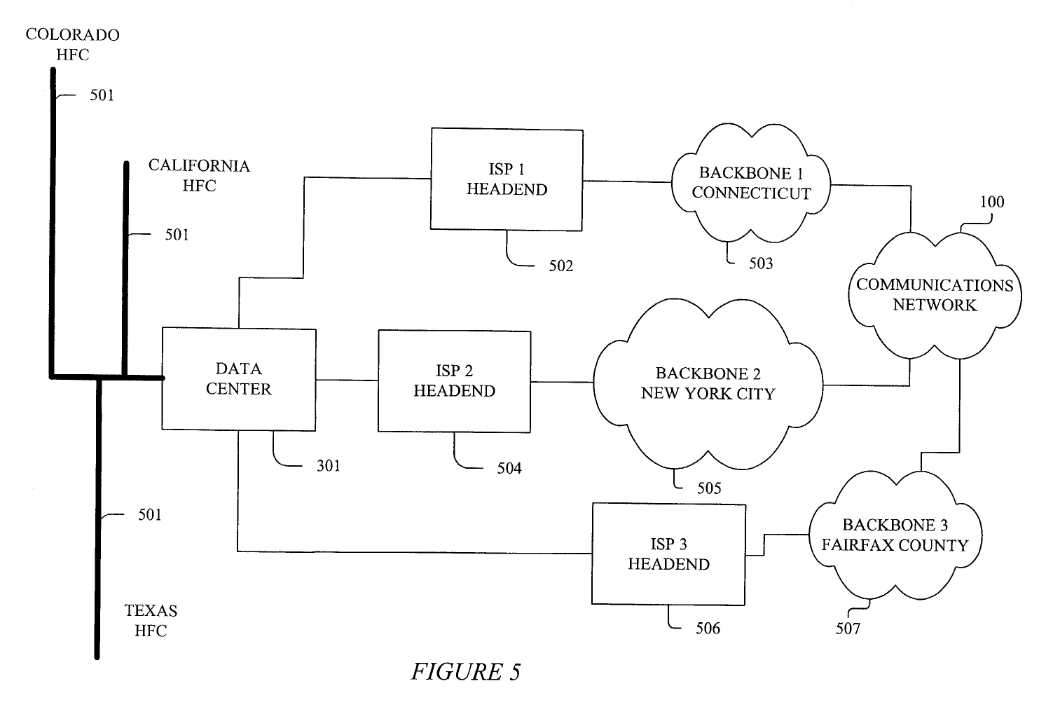

FIG. 5 is a block diagram showing the connectivity of remote customers to geographically based service providers (e.g., ISPs) via the common data center 301 according to one embodiment of the present invention. As shown in FIG. 5, various geographically dispersed HFC networks 501 are connected to a common data center 301. Each of the HFC networks 501 is a high-speed network 300 for providing broadband data transport services. In the exemplary embodiment shown in FIG. 5, the high-speed network 300 is not geographically restricted by, for example, a cable television franchise agreement. As would be understood by those of ordinary skill in the network art, the present invention is equally applicable to other embodiments.

Also shown in FIG. 5 are three exemplary ISP headends 502, 504, 506 representing three ISPs providing connectivity to the Internet 100 via different backbones 503, 505, 507. For example, the ISP 1 headend 502 is connected to the Internet 100 via backbone 1 503 which is based in, for example, Connecticut. In this example, ISP 1 has the cable television franchise for the entire state of Connecticut. Using the system of the present invention, however, ISP 1 would be able to provide ISP services to end-users connected to any one of the HFC networks 501 having connectivity to the common data center 301. Accordingly, ISP 1's Internet access business is no longer restricted to the geographic boundaries of their CATV franchise award.

The common data center 301 of the present invention serves as a clearinghouse for bringing end-users to ISPs. In those embodiments of the present invention where the high-speed network is not geographically restricted, such as the example described above in the context of FIG. 5, the end-users may be from any geographic area served by the high-speed network 300 for providing broadband data transport services. Those customers may or may not be within the geographic boundaries of existing cable television franchise agreements. The ISPs, on the other hand, need not be existing cable television operators. The common data center 301 provides connectivity to end-users for multiple ISPs. The present inventors have recognized that by providing a high-speed network 300 dedicated to broadband data transport services, ISPs gaining access to the high-speed network 300 will be able to (1) offer their customers enhanced Internet access performance since the high-speed network 300 does not have to reserve bandwidth for video (i.e., cable television content), and (2) have the option of extending the geographic reaches of their business.

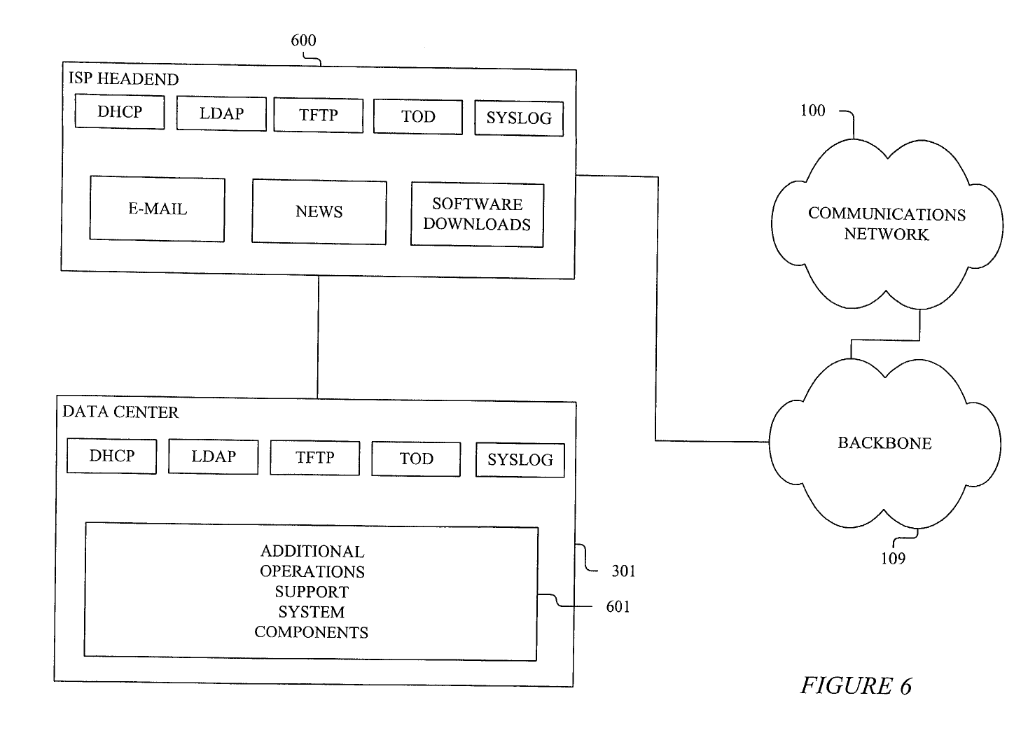

FIG. 6 is a block diagram showing the connectivity between a common data center 301 and an ISP headend 600 according to one embodiment of the present invention. Again, the ISP headend 600 may be for an ISP either having their own network, or an ISP having agreements with network operators (e.g., CATV operators or telephone companies). Both the ISP headend 600 and the common data center 301 provide certain services, such as, for example, Dynamic Host Configuration Protocol (DHCP) services, Lightweight Directory Access Protocol (LDAP) services (typically, but not necessarily integrated with DHCP), Trivial File Transfer Protocol (TFTP) services, Time Of Day (TOD) services, and system logging (SYSLOG) services in order to provide fundamental services to their networks. In one embodiment of the present invention, the ISP headend 600 is further responsible for providing the typical ISP information services provided to the ISP's customers (i.e., the end-users) including, but not limited to e-mail service, news, and software downloads.

The common data center 301 is responsible for managing the high-speed network 300 plant, as well as the interfaces with the various ISPs having customers connected to the high-speed network 300 for providing to broadband data transport services. While the common data center 301 is responsible for providing services related to the physical aspects of the high-speed network 300 (e.g., network availability, asset management, etc.), the individual ISPs connected to the common data center 301 are each responsible for interfacing with their customers. The common data center 301 provides a single integrated operations support system (OSS) 601 through which the physical aspects of the high-speed network 300 may be managed, and through which the individual ISPs having customers connected to the high-speed network 300 may manage their relationship with the operator of the high-speed network 300 for providing broadband data transport services. In one embodiment of the present invention, the operations support system 601 includes a billing capability, a provisioning capability, a general ledger and accounts payable system, a trouble ticketing capability, network monitoring capabilities, service availability capabilities, asset management capabilities, and workforce management capabilities. As would be understood by one of ordinary skill in the software art in light of the present specification, further embodiments of the present invention may include various combinations or sub-combinations of the above-described functional capabilities, or even include additional capabilities including, but not limited to, data warehousing and data mining capabilities.

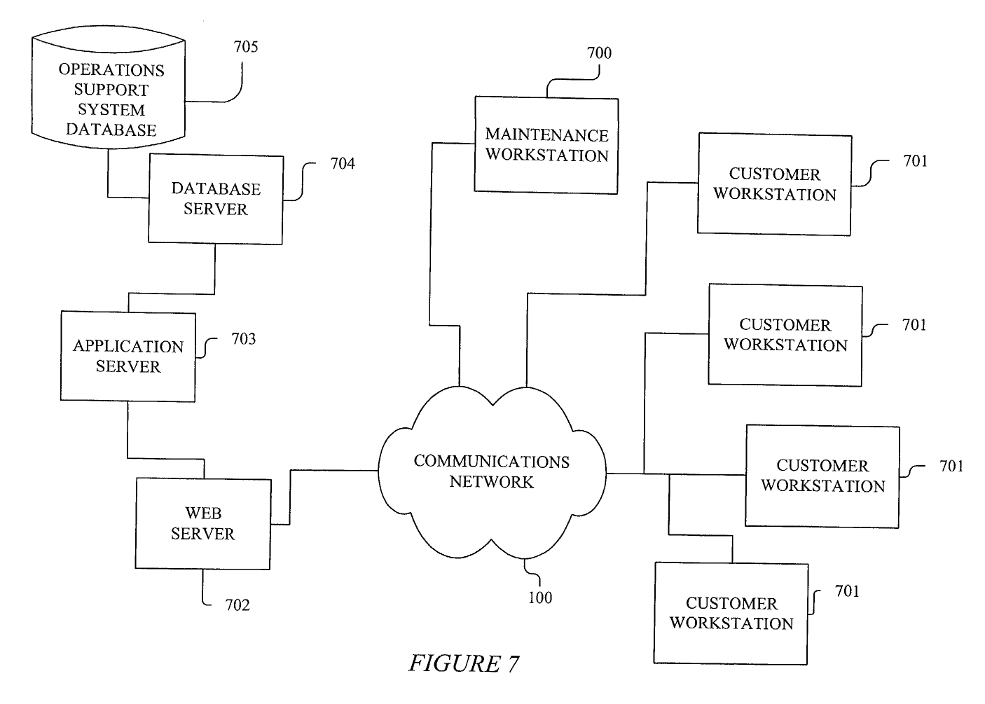

FIG. 7 is a block diagram of a system configuration of an operations support system (OSS) 601 of a common data center 301 as shown in FIG. 6 according to one embodiment of the present invention. As shown in FIG. 7, the system includes a maintenance workstation 700, one or more customer workstations 701 (to provide connectivity for each of the customer ISPs), a communications network 100 (e.g., the Internet), a web server 702, an applications server 703, a database server 704, and an operations support system database 705.

The operations support system database 705 is a digital repository that may be implemented, for example, through a commercially available relational database management system (RDBMS) based on the structured query language (SQL) such as ORACLE, DB2, SYBASE, INFORMIX, or MICROSOFT SQL SERVER, through an object-oriented database management system (ODBMS), or through custom database management software. In one embodiment of the present invention, the operations support system database 705 includes information related to both the physical and usage aspects of the high-speed network 300 for providing broadband data transport services.

For example, the operations support system database 705 includes information related to the plant of the high-speed network 300, including, but not limited to, the geographic availability of the network 300 (i.e., where the high-speed network 300 has been built-out), asset management information, workforce management information including work order status information, trouble ticket information, and network event information. The operations support system database 705 also includes information needed by ISPs having customers on the high-speed network 300. In this regard, as an ISP puts one of their customers onto the high-speed network 300, that ISP becomes a customer of the operator of the high-speed network 300. The operations system support database 705, therefore, includes information such as provisioning information, billing information, general ledger information, and accounts payable information that supports the relationship between the operator of the high-speed network 300 and the ISPs having customers connected to the high-speed network 300.

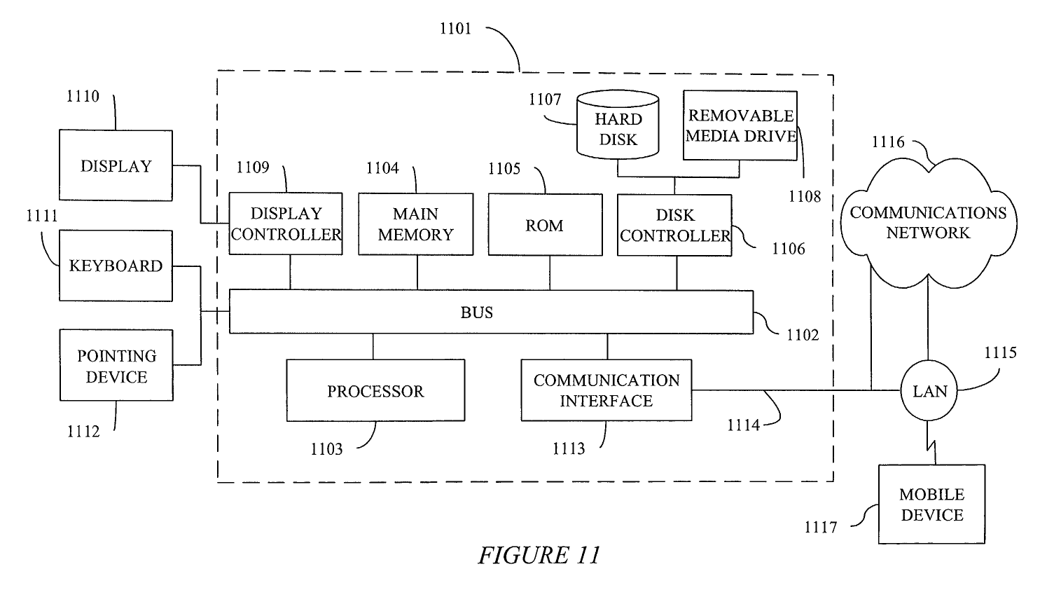

Processes running on the database server 704 maintain the information in the operations support system database 705. The database server 704 is implemented using the computer system 1501 of FIG. 11, for example, but also may be any other suitable personal computer (PC), workstation, server, or device for maintaining the information in the operations support system database 705. The operations support system database 705 may reside on a storage device of the database server 704, or reside on another device connected to the database server 704, for example, by way of a local area network, or other communications link such as a virtual private network, wireless link, or Internet-enabled link.

The applications server 703 may be implemented using the computer system 1501 of FIG. 11, for example, or any other suitable PC, workstation, server, or other device for hosting applications that are used to maintain the various types of information stored in the operations support system database 705. Applications running on the applications server 703 interact with the information held in the operations support system database 705 through the database server 704.

The web server 702 may be implemented using the computer system 1501 of FIG. 11, for example, or any other suitable PC, workstation, server, or other device for hosting an interface through which users may interact with applications running on the applications server 703. In one embodiment of the present invention, the user interface provided by the web server 702 is a world wide web interface accessible through the communications network 100 (e.g., the Internet) via commercially available web browser tools including, but not limited to, INTERNET EXPLORER, available from Microsoft Corporation and NETSCAPE NAVIGATOR, available from Netscape Communications Corporation. The commercially available web browser tool running on the maintenance workstation 700 or the customer workstation 701 provides accessibility to the applications running on the applications server 703 through the web interface provided by the web server 702.

The maintenance workstation 700 may be implemented using the computer system 1501 of FIG. 11, for example, or any other suitable PC, workstation, personal data assistant (PDA), server, or other device for accessing the data in the operations support system database 705 via applications running on the application server 703 through the web based interface provided by the web server 702. In one embodiment, internal personnel may gain access to information in the operations support system database 705 and the applications running on the application server 703 directly (i.e., without going through a common web portal). This direct-access capability is restricted to authorized personnel only. As discussed above, the maintenance workstation 700 may gain access to the web-based interface through a commercially available browser. In one embodiment of the present invention, the maintenance workstation 700 is used to access that information in the operations support system database 705 related to the management of the physical aspects of the high-speed network 300 itself. For example, the maintenance workstation 700 is used to access information relating to network status, trouble ticket status, or work order status. The maintenance workstation 700 is also used for maintaining the operations support system database 705 and the applications running on the application server 703.

The customer workstation 701 may be implemented using the computer system 1501 of FIG. 11, for example, or any other suitable PC, workstation, PDA, server, or other device for accessing information stored in the operations support system database via applications running on the application server 703 through the web based interface provided by the web server 702. As discussed above, the customer workstation 701 may gain access to those applications via a commercially available browser. In one embodiment, the customer workstation 701 is used by ISPs having customers (i.e., end-users) connected to the high-speed network 300. The customer workstation 701 accesses billing information concerning their particular customers, however, ISPs accessing the OSS 601 are restricted from accessing information related to other customers (i.e., other ISPs), nor can they access network management-type information.

In one embodiment of the present invention, strong authentication, authorization and communications integrity are provided for both internal and customer access to the OSS 601. Security may be accomplished through a variety of techniques. For example, security may be imposed at the network level by only accepting traffic from a predetermined set of IP addresses, and by encrypting all data traffic flows using an appropriate technology, such as, for example, Secure Shell (SSH) and Secure HTTP (S-HTTP). User authentication may be performed by using appropriate technologies including, but not limited to, username/password pairs, and one-time password technologies such as SecurelD.

The inventors of the present invention have recognized that by providing a single, integrated operations support system (OSS), multiple ISPs can be supported in a secure and authenticated fashion. Internal personnel responsible for the operation of the OSS maintain a single system with which all of their ISP customers interact. By having a single system, only one interface is needed to perform each of the functions supported for the OSS. By not having custom systems or interfaces for each ISP customer, the complexity of the system is decreased, and the reliability of the system is increased, both of which will reduce the cost of maintaining the OSS.

The inventors of the present invention have also recognized that by developing an integrated OSS to have modular architecture and a common database supporting the functions provided by the OSS, components are easily replaced and functionality is easily added or modified. Furthermore, the present inventors have recognized that it is advantageous to have a common web portal for accessing the OSS since the users of the OSS, in particular the ISP customer users, need not develop any software to gain access to the functionality provided. Accordingly, new customers need only have a web browser in order to gain access to the functionality provided by the OSS.

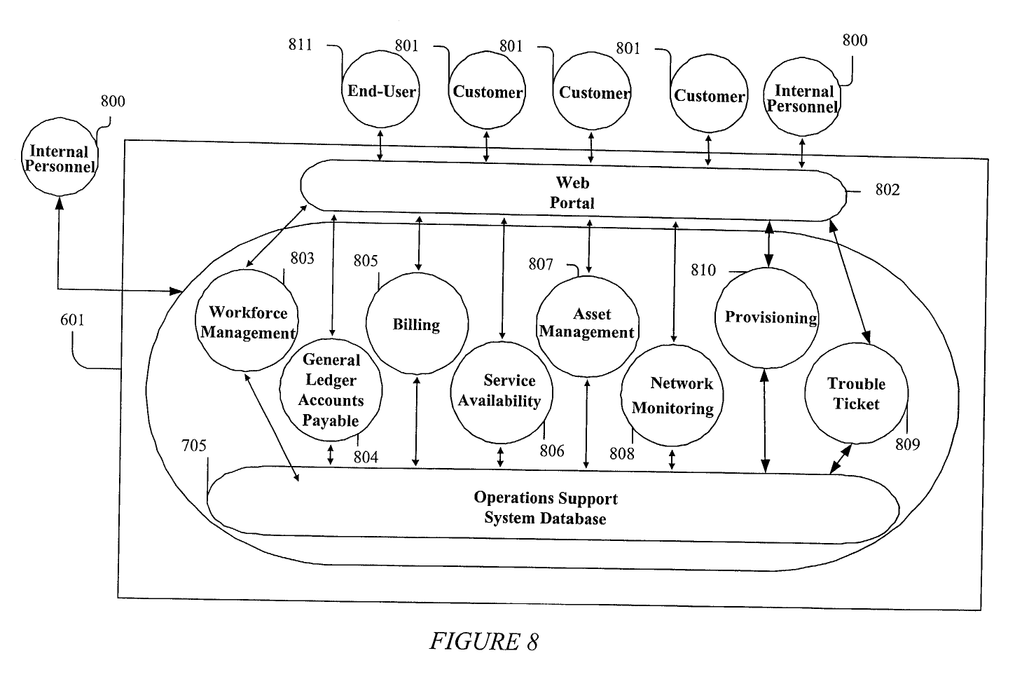

FIG. 8 is a block diagram showing the software architecture of an integrated operations support system (OSS) 601 to support multiple customers (e.g., ISPs) and end-users of the high-speed network 300 according to one embodiment of the present invention. As shown in FIG. 8, the architecture provides a single web portal 802 for all users of the OSS 601. In other words, both internal personnel 800 (i.e., those personnel responsible for the operation of the high-speed network 300), customers 801 (e.g., ISPs having end-users 811 connected to the high-speed network 300) and end-users 811 access the OSS 601 through a single web-based interface, or web portal 802. The web portal 802 provides a single point of access to a variety of software applications through which information in the operations support system database 705 is manipulated. In one embodiment of the present invention, internal personnel 800 may bypass the web portal 802 to gain access to the applications provided by the OSS 601. In this embodiment, as discussed above, this access is restricted to authorized internal personnel 800 only.

In one embodiment of the present invention, the look and feel of the user interface of the web portal 802 is customizable to facilitate integration with established ISP business processes. In one embodiment, the user interface is branded with the logo of the ISP customer. In a further embodiment, sales scripting language (prompts) defined by the ISP may be used through the user interface. In yet another embodiment, the ISP may be given the ability to control account management functions to control which ISP personnel may have access to the OSS 601 via the web portal 802. Any such desired customizations may be provided on a per-customer basis.

In another embodiment of the present invention the web-based user interface is complemented with automated interfaces for certain functional components, for example, billing and provisioning. Having these automated interfaces results in increased system scalability and ISP process efficiencies. These interfaces may be implemented as, for example, an extensible markup language (XML) interface, a file transfer protocol (FTP) interface, an electronic data interchange (EDI) interface, an interface using the rsync Internet protocol, or an electronic mail (e-mail) interface. In another embodiment of the present invention, OSS 601 functionality is accessible through an application programmer's interface (API).

In one embodiment of the present invention, the operations support system database 705 is implemented as a single master ORACLE relational database providing a single common repository accessed by all applications, whether those applications are supporting internal functions for internal personnel 800, or customer functions supporting customers 801. Further embodiments of the present invention use multiple database instances specific to a particular functionality (e.g., billing, provisioning, network monitoring, etc.), each of which is coordinated through a single master database.

In one embodiment of the present invention, customers 801 interact with the web portal 802 via a customer workstation 701, internal personnel 800 interact with the web portal 802 through a maintenance workstation 700 and end-users 811 interact with the web portal 802 through personal computers 106, the web portal 802 is provided by the web server 702, the various applications are hosted by the applications server 703, and the operations support system database 705 is managed by the database server 704.

As shown in FIG. 8, in one embodiment of the present invention, the operations support system 601 includes a workforce management application 803, a general ledger and accounts payable application 804, a billing application 805, a service availability application 806, an asset management application 807, a network monitoring application 808, a trouble ticket application 809, and a provisioning application 810. As discussed above, all of the various software applications are accessible via the common web portal 802 and store and retrieve information from the common operations support system database 705. Of course, the applications included in the OSS 601 may vary with different embodiments of the present invention. The OSS 601 provides an integrated system for managing the high-speed network 300 plant as well as its usage.

As recognized by the present inventors, it is advantageous to provide access to the various applications required to manage the high-speed network 300 itself, as well as its usage, through a common web portal 802 such that customers 801, internal personnel 800 and end-users 811 may access the information stored in the operations support system database 705 by simply having access to a commercially available browser. In other words, no customer software is required by either the operators of the network (i.e., internal personnel 800), the customers 801 (e.g., ISPs) of the network or the end-users 811. Furthermore, the present inventors have recognized that by storing all information in a common operations support system database 705, having a common data model, the sharing of information between the various applications will be facilitated. Moreover, the integrity of the information stored in the operations support system database 705 will be maximized. The present inventors have recognized that it is advantageous, from both a technical and business perspective, to have an integrated OSS 601 based on a common operations support system database 705.

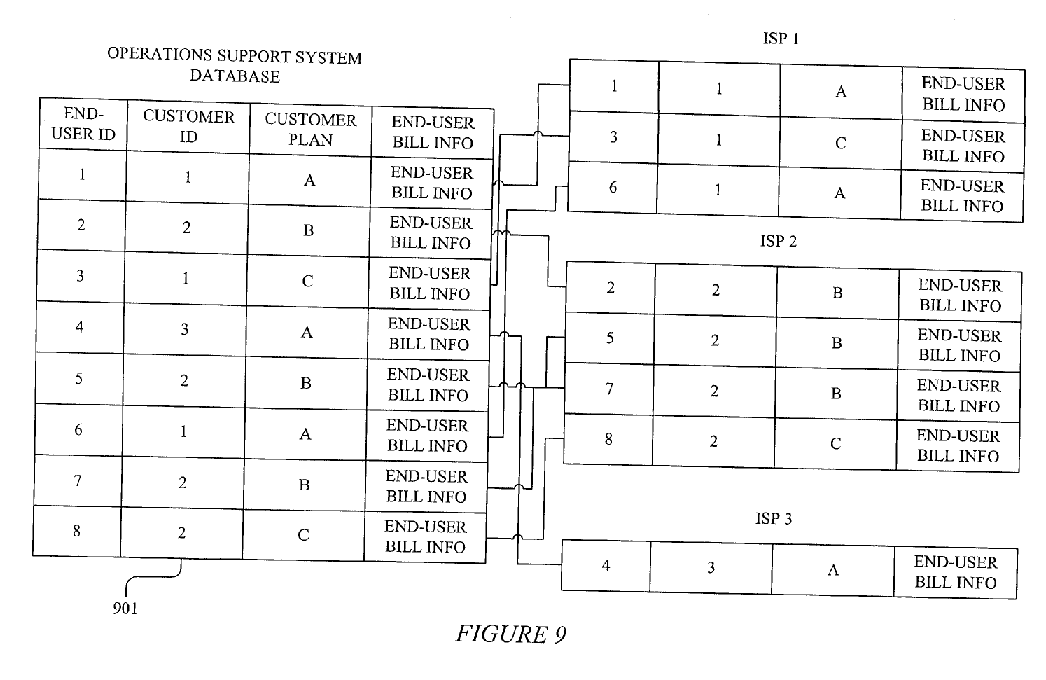

FIG. 9 shows an exemplary database structure for an operations support system database 705 supporting multiple customers 801 (e.g., ISPs) according to one embodiment of the present invention. As shown in FIG. 9, a single query of the operations support system database 705 produces a result 901 that may include several end-users 811 (i.e., individual connections to the high-speed network 300), each end-user 811 being a customer of a particular ISP, each of those ISPs being a customer 801 of the high-speed network 300. Each customer 801 of the high-speed network 300 (e.g., an ISP) may offer a variety of service plans to their customers (i.e., end-users 811). For example, a particular ISP may offer three different rate plans (e.g., customer plan A, customer plan B, customer plan C). Each of those rate plans would cause different billing information to be generated based on the customer plan subscribed to as defined in the billing application 805 for that particular end-user 811.

As customers 801 access information stored in the operations support system database 705, they are restricted from viewing any records other than those corresponding to end-users 811 which are their customers. For example, as shown in FIG. 9, when customer ISP 1 accesses the operations support system database 705 via the web portal 802, ISP 1 will only have access to records relating to end-users 811 having IDs 1, 3, and 6, as those end-users 811 have a customer-provider relationship with ISP 1. Similarly, when customer ISP 2 accesses the operations support system database 705, ISP 2 will only have access to records pertaining to end-users 811 having IDs 2, 5, 7, and 8, and so on. The inventors of the present invention have recognized that from a technical and business perspective, that it is advantageous to store information relating to all of the customers 801 of the high-speed network 300 in a common format in a common operations support system database 705. Accordingly, the operators of the high-speed network 300 need only provide a single user interface to the operations support system 601 that may be accessed by all customers 801. Moreover, the complexity of the operations support system database 705 is minimized, as are the various interfaces between the applications 803-809 and the operations support system database 705. The inventors of the present invention have further recognized that by maintaining information of interest to the operators of the high-speed network 300 and information of interest to the customers 801 in a common operations support system database 705 accessible through a single web portal 802, they have alleviated the need to have separate software applications providing interfaces between a variety of systems.

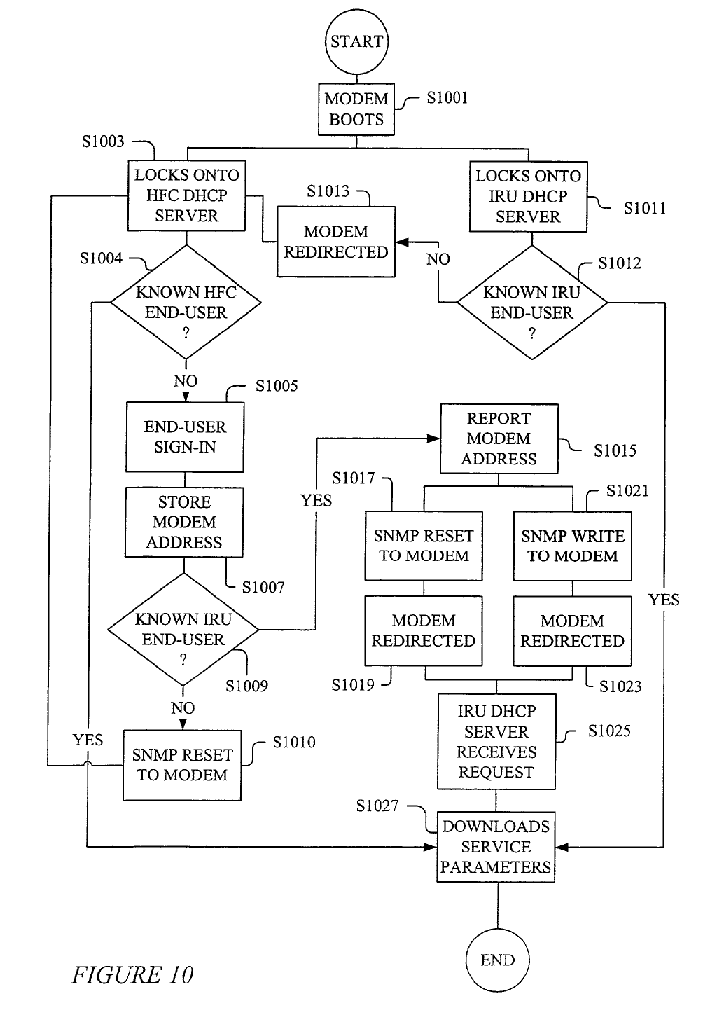

FIG. 10 is a flow diagram showing an exemplary process for Irrevocable Right to Use (IRU) registration. As recognized by the present inventors, current HFC systems using DOCSIS do not allow for traffic to be segregated to specific upstream/downstream channel combinations without complicated manual provisioning techniques involving a MAC address of the cable modem 105 (i.e., a unique address that identifies a cable modem 105 from all other cable modems 105). According to the present invention, an upstream and downstream channel combination is dedicated to a single ISP customer 801 via an IRU (Irrevocable Right to Use) business arrangement. Under such an arrangement, the IRU customer 801 manages all equipment required to provide network connectivity to an end-user 811 thereof, including the cable modem 105, the CMTS, DHCP/TFTP/TOD servers for DOCSIS modem provisioning, and any required routing capabilities upstream of the CMTS 403. The HFC network is used to provide RF connectivity between the cable modem 105 and the CMTS 403.

Accordingly, under such an IRU arrangement, a specified amount of upstream and downstream RF capacity on the HFC network is allocated to a third party (e.g., an IRU customer 801) for their exclusive use. That third party then connects their own CMTS equipment to the HFC network for the purpose of offering third-party broadband data services. In this environment, the third-party CMTS and all associated third-party OSS components and routing components are managed by the third-party under a separate management domain from that of the HFC open access provider. In contrast, non-IRU customers 801 share the remaining RF capacity, which is, for example, under the management domain of the HFC open access provider.

Normally, all end-users 811 of the IRU customer 801 will utilize the upstream/downstream combination assigned to the IRU customer 801. However, due to the nature of DOCSIS technology, it is possible for the IRU cable modem 105 of the IRU customer 801, when it boots, to attempt to gain service using a bandwidth assigned to a non-IRU customer 801. Likewise, a non-IRU cable modem 105 of a non-IRU customer 801 being serviced by the HFC open access provider can attempt to gain service using a bandwidth assigned to the IRU customers 801. The present invention enables the detection of such situations and redirection of the cable modems 105 to the correct upstream/downstream combination of the IRU customers 801 or the non-IRU customers 801.

In FIG. 10, the Operations Support System (OSS) 601 of the HFC open access provider is enabled to create a new user account for an IRU end-user 811, for example, using an approach such as that described in U.S. patent application Ser. No. 09/784,075 filed Feb. 16, 2001, entitled “SYSTEM, METHOD, AND COMPUTER PROGRAM PRODUCT FOR END-USER SELF-AUTHENTICATION” (Attorney Docket No. 202585US-8). At this point, the cable modem 105 can now be booted to obtain service by requesting a dynamic IP address via, for example, DHCP, etc. and service parameters via, for example, TFTP, etc. The following fundamental assumption applies to the following cases: whenever the DHCP server of the IRU customer 801 receives an address request (e.g., a DISCOVER packet, etc.) from an unknown cable modem 105, the DHCP server of the IRU customer 801 instructs the cable modem 105 to repeat that request on an upstream frequency serviced by the DHCP server of the HFC open access provider (i.e., the DHCP server used for servicing the non-IRU cable modems 105).

When the IRU end-user 811 cable modem 105 boots, it will, according to DOCSIS protocol, lock onto the first downstream DOCSIS frequency it finds via a process called ranging. There is no guaranteed algorithm for the order in which a frequency selection is made. For example, the two following scenarios A and B may occur.

In scenario A, after a cable modem 105 boots at step S1001 and the cable modem 105 locks onto the frequency of the HFC open access provider at step S1003, an end-user sign-in process such as that described in U.S. patent application Ser. No. 09/784,075 filed Feb. 16, 2001, entitled “SYSTEM, METHOD, AND COMPUTER PROGRAM PRODUCT FOR END-USER SELF-AUTHENTICATION” is invoked beginning with step S1004.

If the sign-in process determines at step S1004 that the end-user 811 is an end-user of a non-IRU customer 801, provisioning proceeds to step 1027. Otherwise, control is transferred to step S1005 for end-user 811 sign-in. At steps S1005 and S1007, automatic detection and persistent storage of the corresponding cable modem 105 MAC address and authorization of the end-user 811 is performed, which in turn is used to determine the ISP of the end-user 811 at step S1009.

If at step S1009 the sign-in process determines that the end-user 811 belongs to a non-IRU customer 801, the HFC open access DHCP server at step S1010 sends, for example, a Simple Network Management Protocol (SNMP) RESET command to the cable modem 105, which causes the cable modem 105 to lock onto the HFC open access DHCP server at step S1003 and appropriate service parameters are downloaded via steps S1004 and S1027.

If, however, the sign-in process determines at step S1009 that the end-user 811 is an IRU end-user 811, the process via step S1015 immediately informs the corresponding IRU customer 801 DHCP server of the cable modem 105 MAC address via an appropriate communications mechanism (e.g., including but not limited to IPsec tunnels, L2TP tunnels, secure shell (SSH), secure socket layer (SSL), etc.). After such communication has occurred, the sign-in process then resets the cable modem 105 in, for example, one of the ways described through the following two cases.

In the first case, at step S1017, the open access DHCP server sends a SNMP RESET command to the cable modem 105, which causes the cable modem 105 to issue another DISCOVER request at step S1019 to the HFC open access DHCP server. This time the open access DHCP server has knowledge of the cable modem 105 from step S1015 and allocates to the cable modem 105, for example, a TFTP file, etc., which has parameters instructing the cable modem 105 to repeat its DISCOVER request on the frequency of the corresponding IRU customer 801.

In the second case, at step S1021, the HFC open access DHCP server does a direct SNMP write to the cable modem 105 Management Information Base (MIB) database to cause the cable modem 105 at step S1023 to repeat its DISCOVER request on the frequency of the IRU customer 801.

In either of the two cases above, when the IRU customer 801 DHCP server receives the DISCOVER request at step S1025, it has knowledge of the cable modem 105 (e.g., via the communication received from the open access DHCP server step S1015, etc.) and can use, for example, TFTP, etc., at step S1027 to download the appropriate IRU service parameters to the cable modem 105. At this point the IRU cable modem 105 is operational with the correct service level on the upstream/downstream combination of the corresponding IRU customer 801.

Under scenario B, when a cable modem 105 initially is booted at step S1001 and locks onto the upstream/downstream frequency combination of the IRU customer 801 instead of that of the open access provider at step S1011, such that the IRU customer 801 DHCP server has no knowledge of the cable modem 105 as determined at step S1012. The IRU customer 801 DHCP server then responds to the cable modem 105 at step S1013 with, for example, a TFTP file, etc., which contains parameters instructing the cable modem 105 to repeat its DISCOVER request on the frequency served by the open access DHCP server. This in turn triggers the process beginning with step S1003 of scenario A above.

Once the IRU cable modem 105 is operational on the IRU upstream/downstream combination based on the above scenarios A or B, the IRU cable modem 105 may be rebooted at any time. Since the IRU cable modem 105 persistently stores its current frequency, it will in all likelihood send a DISCOVER request on the IRU customer 801 upstream frequency. The IRU customer 801 DHCP server has knowledge of the cable modem 105 via step S1012, and thus provides the appropriate service parameters via, for example, TFTP, etc., at step S1027. If, however, the IRU cable modem 105 locks onto the frequency serviced by the open access DHCP server, this server will also have knowledge of the IRU cable modem 105 and thus will be able to instruct the IRU cable modem 105 to repeat its request on the IRU customer 801 frequency as with the process beginning at step S1009 of scenario A above.

In a similar manner, a non-IRU cable modem 105 of a non-IRU customer 801 may be rebooted at any time as well. Since the non-IRU cable modem 105 persistently stores its current frequency, it will in all likelihood send a DISCOVER request on the HFC open access provider upstream frequency. The DHCP server of the HFC open access provider has knowledge of the non-IRU cable modem 105 via step S1004, and thus provides the appropriate service parameters via, for example, TFTP, etc., at step S1027. If, however, the non-IRU cable modem 105 locks onto the frequency serviced by the IRU customer 801 DHCP server, this server has no knowledge of the non-IRU cable modem 105 via step S1012 and thus instructs the non-IRU cable modem 105 to repeat its request on the frequency of the HFC open access provider as in the process beginning with step S1003 of scenario A above.

Accordingly, as described above, the present invention enables detection and redirection of a cable modem 105 to a correct upstream/downstream combination of an IRU customer 801 or a non-IRU customer 801 of the HFC open access provider.

FIG. 11 illustrates a computer system 1101 upon which an embodiment of the present invention may be implemented. The present invention may be implemented on a single such computer system, or a collection of multiple such computer systems. The computer system 1101 includes a bus 1102 or other communication mechanism for communicating information, and a processor 1103 coupled with the bus 1102 for processing the information. The computer system 1101 also includes a main memory 1104, such as a random access memory (RAM) or other dynamic storage device (e.g., dynamic RAM (DRAM), static RAM (SRAM), and synchronous DRAM (SDRAM)), coupled to the bus 1102 for storing information and instructions to be executed by processor 1103. In addition, the main memory 1104 may be used for storing temporary variables or other intermediate information during the execution of instructions by the processor 1103. The computer system 1101 further includes a read only memory (ROM) 1105 or other static storage device (e.g., programmable ROM (PROM), erasable PROM (EPROM), and electrically erasable PROM (EEPROM)) coupled to the bus 1102 for storing static information and instructions for the processor 1103.

The computer system 1101 also includes a disk controller 1106 coupled to the bus 1102 to control one or more storage devices for storing information and instructions, such as a magnetic hard disk 1107, and a removable media drive 1108 (e.g., floppy disk drive, read-only compact disc drive, read/write compact disc drive, compact disc jukebox, tape drive, and removable magneto-optical drive). The storage devices may be added to the computer system 1101 using an appropriate device interface (e.g., small computer system interface (SCSI), integrated device electronics (IDE), enhanced-IDE (E-IDE), direct memory access (DMA), or ultra-DMA).

The computer system 1101 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1101 may also include a display controller 1109 coupled to the bus 1102 to control a display 1110, such as a cathode ray tube (CRT), for displaying information to a computer user. The computer system includes input devices, such as a keyboard 1111 and a pointing device 1112, for interacting with a computer user and providing information to the processor 1103. The pointing device 1112, for example, may be a mouse, a trackball, or a pointing stick for communicating direction information and command selections to the processor 1103 and for controlling cursor movement on the display 1110. In addition, a printer may provide printed listings of the data structures/information shown in FIGS. 10 and 11, or any other data stored and/or generated by the computer system 1101.

The computer system 1101 performs a portion or all of the processing steps of the invention in response to the processor 1103 executing one or more sequences of one or more instructions contained in a memory, such as the main memory 1104. Such instructions may be read into the main memory 1104 from another computer readable medium, such as a hard disk 1107 or a removable media drive 1108. One or more processors in a multi-processing arrangement may also be employed to execute the sequences of instructions contained in main memory 1104. In alternative embodiments, hard-wired circuitry may be used in place of or in combination with software instructions. Thus, embodiments are not limited to any specific combination of hardware circuitry and software.

As stated above, the computer system 1101 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 1101, for driving a device or devices for implementing the invention, and for enabling the computer system 1101 to interact with a human user (e.g., print production personnel). Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 1103 for execution. A computer readable medium may take many forms, including but not limited to, non-volatile media, volatile media, and transmission media. Non-volatile media includes, for example, optical, magnetic disks, and magneto-optical disks, such as the hard disk 1107 or the removable media drive 1108. Volatile media includes dynamic memory, such as the main memory 1104. Transmission media includes coaxial cables, copper wire and fiber optics, including the wires that make up the bus 1102. Transmission media also may also take the form of acoustic or light waves, such as those generated during radio wave and infrared data communications.

Various forms of computer readable media may be involved in carrying out one or more sequences of one or more instructions to processor 1103 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 1101 may receive the data on the telephone line and use an infrared transmitter to convert the data to an infrared signal. An infrared detector coupled to the bus 1102 can receive the data carried in the infrared signal and place the data on the bus 1102. The bus 1102 carries the data to the main memory 1104, from which the processor 1103 retrieves and executes the instructions. The instructions received by the main memory 1 104 may optionally be stored on storage device 1107 or 1108 either before or after execution by processor 1103.

The computer system 1101 also includes a communication interface 1113 coupled to the bus 1102. The communication interface 1113 provides a two-way data communication coupling to a network link 1114 that is connected to, for example, a local area network (LAN) 1115, or to another communications network 1116 such as the Internet. For example, the communication interface 1113 may be a network interface card to attach to any packet switched LAN. As another example, the communication interface 1113 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1113 sends and receives electrical, electromagnetic or optical signals that carry digital data streams representing various types of information.

The network link 1114 typically provides data communication through one or more networks to other data devices. For example, the network link 1114 may provide a connection to another computer through a local network 1115 (e.g., a LAN) or through equipment operated by a service provider, which provides communication services through a communications network 1116. In preferred embodiments, the local network 1114 and the communications network 1116 preferably use electrical, electromagnetic, or optical signals that carry digital data streams. The signals through the various networks and the signals on the network link 1114 and through the communication interface 1113, which carry the digital data to and from the computer system 1101, are exemplary forms of carrier waves transporting the information. The computer system 1101 can transmit and receive data, including program code, through the network(s) 1115 and 1116, the network link 1114 and the communication interface 1113. Moreover, the network link 1114 may provide a connection through a LAN 1115 to a mobile device 1117 such as a personal digital assistant (PDA), laptop computer, or cellular telephone. The LAN communications network 1115 and the communications network 1116 both use electrical, electromagnetic or optical signals that carry digital data streams. The signals through the various networks and the signals on the network link 1114 and through the communication interface 1113, which carry the digital data to and from the system 1101, are exemplary forms of carrier waves transporting the information. The computer system 1101 can transmit notifications and receive data, including program code, through the network(s), the network link 1114 and the communication interface 1113.

In an HFC open access architecture, the present invention enables upstream and downstream channels to be dedicated to a single IRU customer 801 via an IRU (Irrevocable Right to Use) business arrangement. The HFC network is used to provide RF connectivity between the cable modem 105 and the CMTS 403. Normally all end-users 811 of the IRU customer 801 utilize that upstream/downstream combination. However, due to the nature of DOCSIS technology, it is possible for an IRU cable modem 105, when it boots, to attempt to gain service using a bandwidth assigned to a different customer 801. The present invention enables the detection of such a situation and a redirection of the cable modem 105 to the correct upstream/downstream combination. Thus, one or more dedicated upstream/downstream IRU arrangements may be supported in an open access last-mile environment utilizing, for example, DOCSIS technology, etc., for communication between the cable modem 105 and the CMTS 403. No manual equipment provisioning is required to support such an arrangement.

In contrast, typical HFC systems using DOCSIS do not allow for traffic to be segregated to specific upstream/downstream channel combinations without complicated manual provisioning techniques involving a MAC address of the cable modem 105 (i.e., a unique address that identifies a cable modem 105 from all other cable modems 105). Thus, the present invention allows automatic channel segregation without any manual provisioning of MAC address information, enabling automatic segregation of HFC DOCSIS-based data traffic to specific upstream/downstream channel pairs without manual provisioning of hardware address information.

Obviously, numerous modifications and variations of the present invention are possible in light of the above teachings. It is therefore to be understood that within the scope of the appended claims, the invention may be practiced otherwise than as specifically described herein.

What is claimed is:

1. A method for registering an irrevocable right to use (IRU) in a network supporting one or more IRU service providers connected to the network, comprising the steps of:
locking onto one of an access network dynamic host configuration protocol (DHCP) server and an IRU DHCP server by a modem;
determining if the modem is known by the one of the access network DHCP server and the IRU DHCP server;
downloading service parameters to the modem if it is determined in the determining step that the modem is known;
redirecting the modem to the access network DHCP server to download service parameters if the modem locked onto the IRU DHCP server in the locking step and it was determined in the determining step that the modem was not known by the IRU DHCP server to be a known IRU modem; and
redirecting the modem to the IRU DHCP server to download service parameters if the modem locked onto the access network DHCP server in the locking step and it was determined in the determining step that the modem was not known by the access network DHCP server to be a known access network modem.

2. The method of claim 1, wherein the irrevocable right to use comprises a specified allocation of at least one of an upstream bandwidth and a downstream bandwidth.

3. The method of claim 1, wherein:
the network comprises an open access network managed by a network provider, and
the irrevocable right to use is allocated to a third party.

4. The method of claim 1, further comprising the following steps after the determining step and prior to the downloading step:
detecting a modem address of the modem if the modem locked onto the access network DHCP server in the locking step and it was determined in the determining step that the modem was not known by the access network DHCP server;
storing the modem address in a digital repository; and
ascertaining whether the modem address corresponds to a known IRU modem.

5. The method of claim 4, further comprising the following step prior to the ascertaining step:
providing to an operator of the access network at least one of the modem address and other modem information through at least one of an electronic message and a manual message.

6. The method of claim 4, further comprising the step of:
redirecting the modem to the IRU DHCP server if it is determined in the ascertaining step that the modem corresponds to a known IRU modem.

7. The method of claim 6, further comprising the step of:
resetting the modem with a temporary configuration file if it is determined in the ascertaining step that the modem does not correspond to a known IRU modem, wherein
the temporary configuration file is configured to be used by the modem until the modem is successfully registered.

8. The method of claim 7, further comprising the step of:
reporting by an operator of the access network at least one of the modem address and other modem information to the IRU DHCP server after the modem address becomes a known IRU modem address.

9. The method of claim 7, further comprising the step of:
resetting the modem after the modem address becomes one of a known access network modem address and a known IRU modem address.

10. The method of claim 6, wherein resetting the modem comprises using a simple network management command.

11. The method of claim 1, wherein the service parameters are downloaded using at least one of a trivial file transfer protocol, a file transfer protocol, and another transfer utility.

12. The method of claim 4, wherein the address comprises a media access control address.

13. The method of claim 1, wherein the service parameters are stored in a memory of the modem.

14. The method of claim 13, wherein the memory comprises a management information base of the modem.

15. The method of claim 1, wherein the service parameters comprise at least one of a downstream frequency and an upstream frequency.

16. A system for registering an irrevocable right to use (IRU) in a network supporting one or more IRU service providers connected to the network, comprising:
means for locking onto one of an access network dynamic host configuration protocol (DHCP) server and an IRU DHCP server by a modem;
means for determining if the modem is known by the one of the access network DHCP server and the IRU DHCP server;
means for downloading service parameters to the modem if it is determined in the determining step that the modem is known;
means for redirecting the modem to the access network DHCP server to download service parameters if the modem locked onto the IRU DHCP server in the locking step and it was determined in the determining step that the modem was not known by the IRU DHCP server to be a known IRU modem; and
means for redirecting the modem to the IRU DHCP server to download service parameters if the modem locked onto the access network DHCP server in the locking step and it was determined in the determining step that the modem was not known by the access network DHCP server to be a known access network modem.

17. A system for registering an irrevocable right to use (IRU) in a network supporting one or more IRU service providers connected to the network, comprising:
a processor; and
a computer readable medium encoded with processor readable instructions that when executed by the processor implement
an access network dynamic host configuration protocol (DHCP) server connection mechanism configured to be accessed by modems requesting access to the network,
an IRU DHCP server connection mechanism configured to be accessed by modems requesting access to the network,
an identification mechanism configured to determine if a modem connected to one of the access network DHCP server and the IRU DHCP server is known to the one of the access network DHCP server and the IRU DHCP server,
a service parameter transfer mechanism configured to transfer service parameters to the modem if the identification mechanism determines that the modem is known to the one of the access network DHCP server and the IRU DHCP server,
an access network DHCP server redirecting mechanism configured to redirect the modem to the access network DHCP server to download service parameters if the identification mechanism determines that the modem is not known to the IRU DHCP server as a known IRU modem, and
an IRU DHCP server redirecting mechanism configured to redirect the modem to the IRU DHCP server to download service parameters if the identification mechanism determines that the modem is not known to the access network DHCP server as a known access network modem.

18. The system of claim 17, wherein the irrevocable right to use comprises a specified allocation of at least one of an upstream bandwidth and a downstream bandwidth.

19. The system of claim 17, wherein:
the network comprises an open access network managed by a network provider, and
the irrevocable right to use is allocated to a third party.

20. The system of claim 17, wherein the computer readable medium is further encoded with processor readable instructions that when executed by the processor further implements
an end-user sign-in mechanism configured to detect an address of the modem if it was determined by the identification mechanism that the modem was not known by the access network DHCP server, store the modem address in a digital repository, and determine whether the modem address corresponds to a known IRU modem.

21. The system of claim 20, wherein:
the end-user sign-in mechanism is further configured to reset the modem if it is determined that the modem address does not correspond to a known IRU modem, report the modem address to the IRU DHCP server, and reset the modem if it is determined that the modem address corresponds to a known IRU modem.

22. The system of claim 21, wherein resetting the modem comprises using a simple network management command.

23. The system of claim 17, wherein the service parameters are downloaded using at least one of a trivial file transfer protocol, a file transfer protocol, and another transfer utility.

24. The system of claim 20, wherein the address comprises a media access control address.

25. The system of claim 17, wherein the service parameters are stored in a memory of the modem.

26. The system of claim 25, wherein the memory comprises a management information base of the modem.

27. The system of claim 17, wherein the service parameters comprise at least one of a downstream frequency and an upstream frequency.

28. A computer program product, comprising:
a computer storage medium; and
a computer program code mechanism embedded in the computer storage medium for causing a processor to register an irrevocable right to use (IRU) in a network supporting one or more IRU service providers connected to the network, the computer program code mechanism having,
a first computer code device configured be accessed as an access network dynamic host configuration protocol (DHCP) server by modems requesting access to the network,
a second computer code device configured to be accessed as an IRU DHCP server by modems requesting access to the network,
a third computer code device configured to determine if a modem connected to one of the access network DHCP server and the IRU DHCP server is known to the one of the access network DHCP server and the IRU DHCP server,
a fourth computer code device configured to transfer service parameters to the modem if the third computer code device determines that the modem is known to the one of the access network DHCP server and the IRU DHCP server,
a fifth computer code device configured to redirect the modem to the access network DHCP server to download service parameters if the third computer code device determines that the modem is not known to the IRU DHCP server as an IRU modem, and
a sixth computer code device configured to redirect the modem to the IRU DHCP server to download service parameters if the third computer code device determines that the modem is not known to the access network DHCP server as an access network modem.

29. The computer program product of claim 28, wherein the irrevocable right to use comprises a specified allocation of at least one of an upstream bandwidth and a downstream bandwidth.

30. The computer program product of claim 28, wherein:
the network comprises an open access network managed by a network provider, and
the irrevocable right to use is allocated to a third party.

31. The computer program product of claim 28, wherein the computer program code mechanism further includes
a seventh computer code device configured to detect a modem address of the modem if it was determined by the third computer code device that the modem was not known by the access network DHCP server, store the modem address in a digital repository, and determine whether the modem address corresponds to a known IRU modem.

32. The computer program product of claim 31, wherein:
the seventh computer code device is further configured to redirect the modem to the IRU DHCP server if it is determined that the modem address corresponds to a known IRU modem.

33. The computer program product of claim 32, wherein:
the seventh computer code is further configured to reset the modem with a temporary configuration file if it is determined that the modem does not correspond to a known IRU modem.

34. The computer program product of claim 33, wherein:
the seventh computer code is further configured to report the modem address to the IRU DHCP server after the modem address becomes a known modem address.

35. The computer program product of claim 33, wherein:
the seventh computer code is further configured to reset the modem after the modem address becomes one of a known access network modem address and a known IRU modem address.

36. The computer program product of claim 32, wherein resetting the modem comprises using a simple network management command.

37. The computer program product of claim 28, wherein the service parameters are downloaded using at least one of a trivial file transfer protocol, a file transfer protocol, and another transfer utility.

38. The computer program product of claim 31, wherein the address comprises a media access control address.

39. The computer program product of claim 28, wherein the service parameters are stored in a memory of the modem.

40. The computer program product of claim 39, wherein the memory comprises a management information base of the modem.

41. The computer program product of claim 28, wherein the service parameters comprise at least one of a downstream frequency and an upstream frequency.
